(19) United States
(12) Patent Application Publication
(10) Pub. No.: US 2026/0052539 A1
(43) Pub. Date: Feb. 19, 2026

(54) SIGNAL QUALITY MEASUREMENT METHOD, TERMINAL DEVICE, NETWORK DEVICE AND STORAGE MEDIUM

(71) Applicant: Spreadtrum Communications (Shanghai) Co., Ltd., Shanghai (CN)

(72) Inventors: Huayu ZHOU, Shanghai (CN); Zhengang PAN, Shanghai (CN)

(21) Appl. No.: 19/103,475

(22) PCT Filed: Aug. 11, 2023
(86) PCT No.: PCT/CN2023/112729

§ 371 Date: Feb. 12, 2025

(30) Foreign Application Priority Data
Aug. 12, 2022 (CN) 202210970253.6

(51) Int. Cl. H04W 72/23; H04B 17/318

(52) U.S. Cl. CPC H04W 72/23; H04B 17/318

(57) ABSTRACT

The present disclosure provides a signal quality measurement method, a terminal device, a network device, and a storage medium. The method includes: the terminal device determining, based on a PDCCH or MAC-CE signaling sent by the network device, whether a measurement object is valid, to enable a time instant at which a target cell sends a measurement reference signal to be consistent with the PDCCH or the MAC-CE signaling, and a determination to be made to a time instant for notifying the terminal device to measure the target cell, so that the target cell can achieve energy savings and timely turning-on.

### CROSS-REFERENCE TO RELATED APPLICATIONS

The present disclosure is a national stage of International application No. PCT/CN2023/112729, filed on Aug. 11, 2023, which claims the priority of the Chinese patent application No. 202210970253.6, entitled “SIGNAL QUALITY MEASUREMENT METHOD, TERMINAL DEVICE, NETWORK DEVICE AND STORAGE MEDIUM” filed with the China National Intellectual Property Administration on Aug. 12, 2022. Both of the aforementioned applications are hereby incorporated by reference in their entireties.

### TECHNICAL FIELD

The present disclosure relates to the field of communication technology and, in particular, to a signal quality measurement method, a terminal device, a network device and a storage medium.

### BACKGROUND

In the 5th Generation (5G) network, due to abundant spectrum resources, when the network has a low load, a cell corresponding to a certain frequency band (such as 4GHz, 6GHZ, or the like) does not need to carry data, nor does it need to send common signals and/or common channels, that is, it can be turned on or off as required. The cell that can be turned on or turned off as required may be referred to as a non-anchor cell, a switching target cell, or a target cell.

In related technologies, before turning-on of a non-anchor cell (i.e., a terminal device switches from an anchor cell to a non-anchor cell), an anchor cell needs to determine, based on location information of the terminal device, the non-anchor cell suitable for serving the terminal device. That is, the anchor cell can notify the non-anchor cell to send a measurement reference signal to the terminal device and notify the terminal device to measure signal quality of the non-anchor cell, so that the anchor cell can determine, based on a measurement result from the terminal device, the non-anchor cell suitable for serving the terminal device. However, it remains an urgent problem to be solved with regard to the timing for the anchor cell to notify the terminal device to measure the signal quality of the non-anchor cell, and enable the non-anchor cell to achieve energy savings and timely turning-on.

### SUMMARY

The present disclosure provides a signal quality measurement method, a terminal device, a network device and a storage medium, which solves a problem of when to notify the terminal device to measure signal quality of a non-anchor cell, enabling the non-anchor cell to achieve energy savings and timely turning-on.

In a first aspect, the present disclosure provides a signal quality measurement method, including:
determining, based on a physical downlink control channel PDCCH or medium access control-control element MAC-CE signaling, whether a measurement object is valid.

In a second aspect, the present disclosure provides a signal quality measurement method, including:
based on radio resource control RRC signaling, determining, after a first time gap, that a measurement object is valid.

In a third aspect, the present disclosure provides a signal quality measurement method, including:
sending a physical downlink control channel PDCCH or medium access control-control element MAC-CE signaling to indicate whether a measurement object is valid.

The present disclosure provides the signal quality measurement method, the terminal device, the network device, and the storage medium. The terminal device determines, based on the PDCCH or the MAC-CE signaling sent by the network device, whether the measurement object is valid, to enable a time instant at which the target cell sends the measurement reference signal to be consistent with the PDCCH or the MAC-CE signaling, and a determination to be made to a time instant for notifying the terminal device to measure the target cell.

### BRIEF DESCRIPTION OF DRAWINGS

Accompanying drawings herein are incorporated into the specification and form a part of the specification, illustrating embodiments in accordance with the present disclosure and used together with the specification to explain principles of the present disclosure.

FIG. 1 is a schematic diagram of an application scenario provided by an embodiment of the present disclosure.

FIG. 2 is a flowchart diagram of a signal quality measurement method provided by Embodiment 1 of the present disclosure.

FIG. 3 is a flowchart diagram of another signal quality measurement method provided by Embodiment 2 of the present disclosure.

FIG. 4 is a schematic structural diagram of a signal quality measurement apparatus provided by Embodiment 5 of the present disclosure.

FIG. 5 is a schematic structural diagram of a signal quality measurement apparatus provided by Embodiment 6 of the present disclosure.

FIG. 6 is a schematic structural diagram of a signal quality measurement apparatus provided by Embodiment 7 of the present disclosure.

FIG. 7 is a schematic structural diagram of a signal quality measurement apparatus provided by Embodiment 8 of the present disclosure.

FIG. 8 is a schematic structural diagram of a terminal device provided by Embodiment 9 of the present disclosure.

FIG. 9 is a schematic structural diagram of a terminal device provided by Embodiment 10 of the present disclosure.

FIG. 10 is a schematic structural diagram of a network device provided by Embodiment 11 of the present disclosure.

FIG. 11 is a schematic structural diagram of a network device provided by Embodiment 12 of the present disclosure.

Through the above accompanying drawings, specific embodiments of the present disclosure have been shown, and more detailed descriptions will be provided in the following text. These accompanying drawings and textual descriptions are not intended to limit the scope of the present disclosure in any way, but rather to illustrate the concept of the present disclosure for those skilled in the art with reference to specific embodiments.

### DESCRIPTION OF EMBODIMENTS

Here, exemplary embodiments will be described in detail, with examples shown in the accompanying drawings. When referring to the accompanying drawings, unless otherwise indicated, the same numbers in different accompanying drawings represent the same or similar elements. Implementations described in the following exemplary embodiments do not represent all implementations consistent with the present disclosure. On the contrary, they are only examples of devices and methods consistent with some aspects of the present disclosure as described in the appended claims.

The technical solution in embodiments of the present disclosure can be applied to various communication systems, such as the Long Term Evolution (LTE) system, LTE Frequency Division Duplex (FDD) system, LTE Time Division Duplex (TDD), Universal Mobile Telecommunication System (UMTS), Worldwide Interoperability for Microwave Access (WiMAX) communication system, 5G mobile communication system, or New Radio Access Technology (NR); where the 5G mobile communication system can include Non-Standalone (NSA) and/or Standalone (SA) networks.

The technical solution provided by the present disclosure can also be applied to the Machine Type Communication (MTC), Long Term Evolution-Machine (LTE-M), Device to Device (D2D) network, Machine to Machine (M2M) network, Internet of Things (IOT) network, or other networks; where the IoT network can include, for example, the Internet of Vehicles; and communication methods in the Internet of Vehicles system are collectively referred to as Vehicle to X (V2X, where X can represent anything). For example, the V2X can include: Vehicle to Vehicle (V2V) communication, Vehicle to Infrastructure (V2I) communication, Vehicle to Pedestrian (V2P) or Vehicle to Network (V2N) communication, or the like

The technical solution provided by the present disclosure can also be applied to future communication systems, such as the sixth-generation mobile communication system, the seventh generation mobile communication system, and the like; which is not limited by the present disclosure.

In order to provide a clearer explanation of the present disclosure, the following will first introduce the relevant technologies involved in the present disclosure.

In the 5G network, due to the abundance of spectrum resources, when the network has a low load, a cell corresponding to a certain frequency band (such as 4GHz, 6GHZ, or the like) does not need to carry data, nor does it need to send common signals and/or common channels, that is, it can be turned on or off according to requirements. The carrier or the cell that can be turned on or turned off as required may be referred to as a non-anchor carrier or a non-anchor cell, and the non-anchor cell can be referred as a switching target cell or a target cell.

Relatively speaking, a cell that is not turned off may be referred to as an anchor carrier or an anchor cell, or referred as a Type 1 Carrier or a Type 1 Cell.

### (1) Anchor Cell and Target Cell (Non-Anchor Cell)

In carrier aggregation (CA)/dual connection (DC), there are the following two scenarios for the anchor cell and target cell.

### Scenario 1

The anchor cell is a primary carrier or primary carrier component or primary cell (PCell) or primary secondary cell (PSCell), that is, a carrier or a cell that mainly carries control signaling.

The target cell is usually a secondary carrier, secondary carrier component, or secondary cell (SCell), that is, a carrier or a cell that mainly carries data.

In this scenario, switching for the target cell can be understood as adding, deleting, or modifying the secondary cell. Requirements for a backhaul network between the anchor cell and the target cell are relatively high, but the switching for the target cell is easier to implement (through addition, deletion, or modification of the secondary cell).

### Scenario 2

The anchor cell and the target cell are both the primary carriers, primary carrier components, primary cells, or primary secondary cells, that is, the carriers or cells that mainly carry the control signaling. At this time, turning-on of the target cell can be taken as a switch (Switch) from the anchor cell to the target cell, while turning-off of the target cell can be understood as a switch from the target cell to the anchor cell.

In this scenario, the requirements for the backhaul network between the anchor cell and the target cell are relatively low, but the switching for the target cell would be implemented with high complexity.

In the non-CA/DC, the anchor cell and target cell are similar to the Scenario 2 described above. The turning-on of the target cell can be understood as a switch from the anchor cell to the target cell, while the turning-off of the target cell can be understood as a switch from the target cell to the anchor cell. At this time, the requirement for the backhaul network between the anchor cell and the target cell is relatively low, but the switching for the target cell would be implemented with high complexity.

### (2) Turning-On of Target Cell

Generally speaking, a process of turning on the target cell as required can be divided into the following two situations.

### Situation 1

The target cell can be turned on at an occasion before a terminal device completing a random access. This can enable the terminal device to use resources of the target cell as soon as possible (enabling the target cell to provide more load balancing), and reduce signaling overheads during a handover (HO) in a connected state.

The random access process is generally divided into four steps, respectively corresponding to four channels or messages of a random access channel. The four messages include: a Physical Random Access Channel (PRACH), also known as Message 1 (Msg1), a Random Access Response (RAR), also known as Message 2 (Msg2), Message 3 (Msg3), and Message 4 (Msg4). The target cell can be turned on at an occasion before the terminal device initiating the random access, that is, before sending the PRACH. In this way, the terminal device can initiate the random access or a Random Access Channel (RACH) process on the target cell, using the PRACH on the target cell.

The target cell can also be turned on at an occasion after the terminal device initiating the random access and before completing the random access, for example, before sending Message 3. In this way, a transfer to the target cell can be performed as quick as possible after the terminal device initiates the random access on the anchor cell.

### Situation 2

The target cell can be turned on at an occasion after the terminal device completing the random access, that is, after completing an initial access or entering a connected state. This can enable the target cell to only serve the terminal device in the connected state, increasing a shutdown time of the target cell, and making the target cell more energy-efficient.

The cell switching can be understood as switching from one cell to another cell when the terminal device is in the connected state. The original serving cell no longer provides services to the terminal device, in order to prevent service interruption, a wireless carrier system will search for the most suitable target cell to provide follow-up services to the terminal device, achieving mobility management with seamless wireless network coverage.

In Situation 2 described above, when in the connected state, the terminal device can switch from the anchor cell to the target cell. Before switching, the anchor cell needs to determine information of the terminal device, for example, into which target cell the terminal device falls in terms of coverage and which target cell is suitable for serving the terminal device.

In general, there are the following three methods for the anchor cell to determine the information of the terminal device.

Method 1: The target cell does not send a measurement reference signal.

The anchor cell obtains location information of the terminal device based on measurement information reported by the terminal device, for example, Layer 1 measurement reports, such as Channel Quality Indicator (CQI), Layer 1 Reference Signal Receiving Power (RSRP) and Layer 1 Signal to Interference plus Noise Ratio (SINR), as well as Layer 3 measurement reports (such as Layer 3 RSRP, Layer 3 SINR and the like), and then determines into which target cell the terminal device falls in terms of coverage or which target cell is suitable for serving the terminal device. In this way, the target cell can achieve the energy savings without sending the measurement reference signal, but it is required that the anchor cell should be capable to infer an approximate location of the terminal device. Even though, the anchor cell still has difficulty to accurately determine into which target cell the terminal device falls in terms of coverage or which target cell is suitable for serving the terminal device.

Method 2: the target cell continuously sends a measurement reference signal.

Since the terminal device is then in the connected state, a base station can configure measurement of the target cell to the terminal device through high-level signaling, by configuring the measurement reference signal of the target cell in a measurement object (MO). Through the measurement report of the terminal device, the anchor cell can determine into which target cell the terminal device falls in terms of coverage or which target cell is suitable for serving the terminal device. In this way, the anchor cell can better determine into which target cell the terminal device falls in terms of coverage or which target cell is suitable for serving the terminal device. However, the target cell needs to continuously send the measurement reference signal; although configuring a long measurement window period can reduce energy consumption of the target cell, the energy consumption of the target cell is still relatively high.

Method 3: The target cell sends a measurement reference signal as required.

The anchor cell can notify the target cell to start transmission of the measurement reference signal and notify the terminal device to measure the target cell. The terminal device measures the target cell and reports a measurement result to the anchor cell. In this way, not only the goal of energy savings can be achieved by reducing transmission of the measurement reference signal, but also the measurement report of the target cell enables the anchor cell to better determine into which target cell the terminal device falls in terms of coverage or which target cell is suitable for serving the terminal device.

In the Method 3 described above, advancing of the time of notification by the anchor cell will result in early transmission by the target cell of the measurement reference signal, which is not conducive to the energy savings of the target cell and also increases measurement burden and energy consumption of the terminal device. While delaying of the time of notification may result in late transmission by the terminal device of the measurement reference signal, resulting in measurement lag of the terminal device and a possibility that the target cell is not turned on in a timely manner. Therefore, it remains an urgent problem to be solved with regard to the timing for the anchor cell to notify the terminal device to measure the target cell (or the timing for the target cell to start transmission of the measurement reference signal, or the timing for the measurement reference signal of the target cell to be valid).

In view of this, an embodiment of the present proposes a signal quality measurement method, in which the terminal device determines, through a physical downlink control channel (PDCCH) or medium access control-control element (MAC-CE) signaling sent by the network device, whether an measurement object is valid, to enable a time instant at which the target cell sends the measurement reference signal to be consistent with the PDCCH or the MAC-CE signaling, and a determination to be made to a time instant to notify the terminal device to measure the target cell, so that the target cell can achieve the energy savings and timely turning-on.

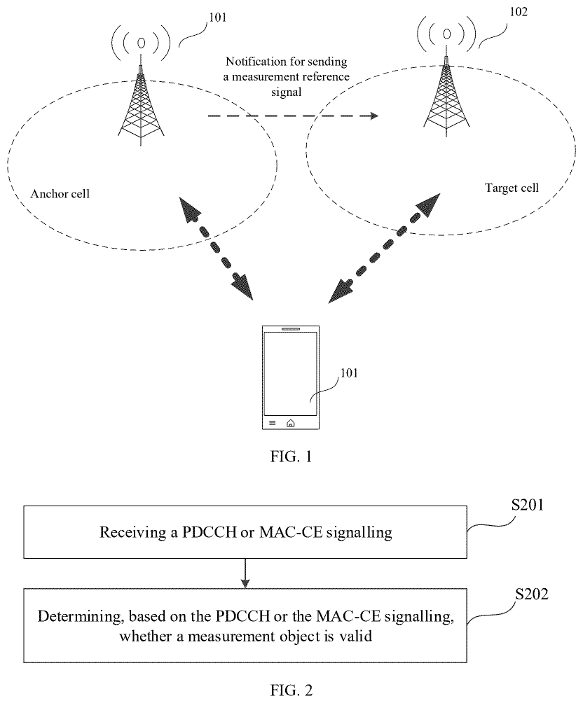

For ease of understanding, application scenarios applicable to the embodiments of the present disclosure will be explained below in conjunction with FIG. 1.

Cell switching can generally be divided into: a switch between cells within a base station (i.e., an anchor cell and a target cell belong to the same base station) and a switch between cells across different base stations (i.e., an anchor cell and a target cell belong to different base stations).

For the switch between cells within the base station, the base station can turn on or turn off the target cell as required; for the switch between cells across different base stations, the base station for the anchor cell can use inter base station signaling to enable the base station for the target cell to turn on or turn off the target cell as required. Alternatively, the base station of the target cell can turn on or off the target cell according to requirement based on core network commands or signal/load requirements. The following application scenarios are explained based on the switch between cells across different base stations.

FIG. 1 is a schematic diagram of an application scenario provided by an embodiment of the present disclosure. Please refer to FIG. 1, which includes: a terminal device 101, a base station 102 for an anchor cell, and a base station 103 for a target cell. The base station 102 for the anchor cell sends a notification to the base station 103 for the target cell, and sends a PDCCH or MAC-CE signaling to the terminal device 101, so that the base station 103 for the target cell sends a measurement reference signal to the terminal device 101, enabling the terminal device 101 to determine, based on the PDCCH or the MAC-CE signaling, whether a measurement object is valid, in order to achieve energy savings and timely turning-on of the target cell.

It can be understood that the terminal device 101, the base station 102, and the base station 103 can all be plural in number, not shown in the figure. The terminal device 101 can be a mobile phone, a tablet computer (Pad), a computer with wireless transmission and reception functions, a virtual reality (VR) terminal device, an augmented reality (AR) terminal device, a wireless terminal in industrial control, a vehicular terminal device, a wireless terminal device in self driving, a road side unit (RSU), a wireless terminal device in remote medical, a wireless terminal device in smart grid, a wireless terminal device in transportation safety, a wireless terminal device in smart city, a wireless terminal device in smart home, a wearable terminal device, and the like. The terminal device 101 involved in the embodiments of the present disclosure can also be referred to as a terminal, a terminal device (User Equipment, UE), an access terminal device, a vehicle terminal, an industrial control terminal, a UE unit, a UE station, a mobile station, a mobile platform, a remote station, a remote terminal device, a mobile device, a wireless communication device, a UE agent or a UE apparatus, or the like. The terminal device 101 can also be fixed or mobile.

The base station 102 and the base station 103 are devices with wireless transmission and reception capabilities, including but not limited to: an evolutional Node B (eNB or eNodeB) in LTE, a gNodeB or a gNB (gNodeB or gNB) or a transmission and receiving point (TRP) in NR, a base station in subsequent evolutional systems, an access node in a Wireless Fidelity (Wireless Fidelity, WiFi) system, a wireless relay node, a wireless backhaul node, and the like. The base stations can be macro base stations, micro base stations, picocells, small stations, relay stations, or the like.

Below is a detailed explanation of the technical solution of the present disclosure and how the technical solution of the present disclosure solves the above technical problems through specific embodiments. The following specific embodiments can exist independently or be combined with each other. For the same or similar concepts or processes, they may not be repeated in some embodiments. Below, the embodiments of the present disclosure will be described in conjunction with the accompanying drawings.

FIG. 2 is a flowchart diagram of a signal quality measurement method provided by Embodiment 1 of the present disclosure. The method can be executed by a terminal device. Referring to FIG. 2, the method includes the following steps.

S201, receiving a PDCCH or MAC-CE signaling.

The terminal device can measure a target cell by means of receiving the PDCCH or the MAC-CE signaling sent by a network device.

S202, determining, based on the PDCCH or the MAC-CE signaling, whether a measurement object is valid.

The terminal device dynamically adds the measurement object to a measurement object list (MO List) based on the PDCCH or the MAC-CE signaling, so that the terminal device can perform signal measurement on the target cell to determine whether the measurement object is valid. That is to say, due to fast transmission of the PDCCH or the MAC-CE signaling, a time instant at which the target cell sends the measurement reference signal (a valid time instant) can be consistent with the PDCCH or the MAC-CE signaling, or a time instant at which the target cell does not send the measurement reference signal (an invalid time instant) can be consistent with the PDCCH or the MAC-CE signaling, which can effectively solve the problem that when to notify the terminal device, by an anchor cell, to measure the target cell (or when to start transmission of a measurement reference signal by the target cell).

In an implementation, the above measurement object includes a measurement reference signal, where the measurement reference signal is a measurement reference signal on the target cell.

In an implementation, the measurement reference signal includes a synchronization information block that can provide timing functionality and can be used independently for the signal measurement.

In an implementation, the PDCCH or the MAC-CE signaling includes an identity (ID) of the measurement object. Due to the fact that each measurement object in the measurement object list has a corresponding ID, which means that the measurement object indicated as valid or invalid has already been configured in the measurement object list, it is therefore only necessary to indicate through the MAC-CE signaling whether this object is valid.

In an implementation, the PDCCH or the MAC-CE signaling includes an index or a number of the measurement object. It should be noted that the index or the number of the measurement object is specifically used for the measurement object of the measurement reference signal of the target cell. That is to say, the network device only indexes or numbers the measurement object of the measurement reference signal of the target cell. This index or number is numerically small, which can reduce bit overheads of the PDCCH or the MAC-CE signaling.

In an implementation, the PDCCH or the MAC-CE signaling includes first information of the measurement object in a candidate measurement object list, where the first information includes any one of the ID, the index, and the number. It should be noted that the measurement object being valid can be equivalent to adding the measurement object from the candidate measurement object list to the measurement object list, and the measurement object being invalid can be equivalent to deleting the measurement object from the measurement object list. In this way, by using the candidate measurement object list, the measurement object can be dynamically added or removed from the measurement object list, and the ID, the index or the number in the candidate measurement object list is numerically small, which can reduce the bit overheads of the PDCCH or the MAC-CE signaling.

In an implementation, the PDCCH or the MAC-CE signaling includes one or more PCIs from a physical cell identity (PCI) list of the measurement object. Since one measurement object may correspond to multiple PCIs (through a PCI list), one or more PCIs can be specifically indicated through the PDCCH or the MAC-CE signaling, which can accurately indicate the measurement object of the measurement reference signal of the target cell.

In an implementation, the PDCCH or the MAC-CE signaling includes a PCI index or number, where the PCI index or number corresponds to the one or more PCIs in the PCI list. In this way, due to the limited number of measurement objects for the measurement reference signal of the target cell, the bit overheads of the PDCCH or the MAC-CE signaling can be reduced through the PCI index or the PCI number.

In an implementation, the PDCCH or the MAC-CE signaling includes a synchronization measurement timing configuration (SMTC) of the measurement object. Since one measurement object may correspond to multiple SMTCs (such as SMTC1, SMTC2, and the like), specifying one or more SMTCs through the PDCCH or the MAC-CE signaling can accurately indicate the measurement object of the measurement reference signal of the target cell.

In an implementation, the PDCCH or the MAC-CE signaling includes an SMTC index or number, where the SMTC index or number corresponds to one or more SMTCs. That is to say, the SMTC index or the SMTC number is indicated through the PDCCH or the MAC-CE signaling to indicate the SMTC(s) of the measurement object. In this way, due to the limited number of measurement objects for the measurement reference signal of the target cell, the bit overheads of the PDCCH or the MAC-CE signaling can be reduced through the SMTC index or the SMTC number.

In an implementation, based on the PDCCH or the MAC-CE signaling, the terminal device can determine, after a first time gap, whether the measurement object is valid. This allows the target cell to send the measurement reference signal at a time instant slightly later than a time point of the PDCCH or the MAC-CE signaling, giving the terminal device a buffer time to initiate modifications to the measurement object.

In an implementation, the first time gap is a preset time gap, so that the terminal device may not need to configure the time gap in the PDCCH or the MAC-CE signaling, and the use of a time gap default to the terminal device can reduce signaling overheads.

In an implementation, the first time gap is a configured time gap, which allows the network device to obtain more flexibility by configuring the time gap in the PDCCH or the MAC-CE signaling. For example, the anchor cell determines a size of buffer time that needs to be configured based on capabilities of the terminal device.

In this embodiment, due to the fast transmission of the PDCCH or the MAC-CE signaling, the terminal device determines, through the PDCCH or the MAC-CE signaling sent by the network device, whether the measurement object is valid, to enable the time instant at which the target cell sends the measurement reference signal to be consistent with the PDCCH or the MAC-CE signaling, and a determination to be made to the time to notify the terminal device to measure the target cell, so that the target cell can achieve energy savings and timely turning-on.

In the following, another signal quality measurement method will be explained by means of Embodiment 2, where the terminal device measures the target cell through Radio Resource Control (RRC) signaling.

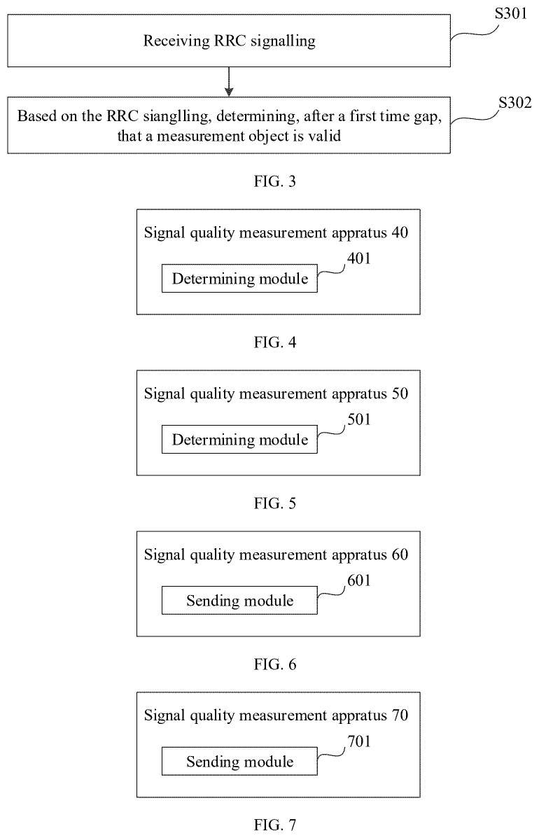

FIG. 3 is a flowchart diagram of another signal quality measurement method provided by Embodiment 2 of the present disclosure. The method can be executed by a terminal device. Referring to FIG. 2, the method includes the following steps.

S301, receiving RRC signaling.

A terminal device can measure a target cell by receiving RRC signaling (such as RRC reconfiguration signaling) sent by a network device.

S302, based on the RRC signaling, determining, after a first time gap, that a measurement object is valid.

When receiving the RRC signaling, the terminal device dynamically adds the measurement object to a measurement object list, and starts measurement of the measurement object after the first time gap; or adds the measurement object to the measurement object list after the first time gap, so that the terminal device can start measurement of the target cell after the first time gap, to determine that the measurement object is valid. It can be understood that when the RRC signaling is invalid, the terminal device does not need to determine that the measurement object is invalid.

In this way, due to slow transmission of the RRC signaling, a time instant at which the target cell sends a measurement reference signal may slightly lag behind compared to a time point of the RRC signaling, which can minimize the transmission of measurement reference signals by the target cell, to achieve the goal of energy savings, and effectively solve the problem regarding when to notify the terminal device by the anchor cell to measure the target cell (or when to start transmission of the measurement reference signal by the target cell), and also give the terminal device a buffer time to initiate modifications to the measurement object.

Generally speaking, this first time gap includes a lagged time gap for the target cell to send the measurement reference signal and a buffer time gap for the terminal device.

In an implementation, the above measurement object includes a measurement reference signal, where the measurement reference signal is a measurement reference signal on the target cell.

In an implementation, the measurement reference signal includes a synchronization information block that can provide timing functionality and can be used independently for signal measurement.

In an implementation, the first time gap is a preset time gap, so that the terminal device does not need to configure the time gap in the PDCCH or the MAC-CE signaling; and using the default time gap of the terminal device can reduce signaling overheads.

In an implementation, the first time gap is a configured time gap. The network device can obtain more flexibility by configuring the time gap in the PDCCH or the MAC-CE signaling. For example, based on current network conditions, the anchor cell can flexibly configure a time gap in which the time instant for the target cell to send the measurement reference signal lags behind the arrival time of the transmission of the RRC signaling, achieving a compromise or balance between timely turning-on and energy consumption reduction of the target cell.

In this embodiment, due to the slow transmission of the RRC signaling, after the first time gap, the terminal device determines, based on the RRC signaling sent by the network device, that the measurement object is valid, so that the time instant at which the target cell sends the measurement reference signal may be slightly later than the arrival time of the RRC signaling. This can minimize the transmission of measurement reference signals by the target cell and achieve the goal of energy savings.

In the following, a signal quality measurement method with a network device being an executive subject will be explained through Embodiments 3 and 4.

Another signal quality measurement method provided by Embodiment 3 of the present disclosure can be executed by a network device.

The network device sends a PDCCH or MAC-CE signaling to a terminal device to indicate whether a measurement object is valid, that is, to give an indication to the terminal device to dynamically add the measurement object to a measurement object list, so that the measurement object is dynamically added to the measurement object list when the terminal device receives the PDCCH or the MAC-CE signaling. In such a way, the terminal device can start measurement of the target cell.

In an implementation, the PDCCH or the MAC-CE signaling includes an identity ID of the measurement object.

In an implementation, the PDCCH or the MAC-CE signaling includes an index or a number of the measurement object.

In an implementation, the PDCCH or the MAC-CE signaling includes first information of the measurement object in a candidate measurement object list, where the first information includes any one of the ID, the index, and the number.

In an implementation, the PDCCH or the MAC-CE signaling includes one or more PCIs from a physical cell identity PCI list of the measurement object.

In an implementation, the PDCCH or the MAC-CE signaling also includes a PCI index or number, where the PCI index or number corresponds to the one or more PCIs in the PCI list.

In an implementation, the PDCCH or the MAC-CE signaling includes an SMTC of the measurement object.

In an implementation, the PDCCH or the MAC-CE signaling also includes an SMTC index or number, where the SMTC index or number corresponds to one or more SMTCs.

For the description of configuration information in the PDCCH or the MAC-CE signaling, please refer to Embodiment 1, and details will not be repeated here.

In this embodiment, due to fast transmission of the PDCCH or the MAC-CE signaling, the network device sends the PDCCH or the MAC-CE signaling to the terminal device, giving an indication to the terminal device to determine whether the measurement object is valid, so that the time instant at which the target cell sends the measurement reference signal can be consistent with the PDCCH or the MAC-CE signaling, and a determination can be made to the time instant for notifying the terminal device to measure the target cell, enabling the target cell to achieve the energy savings and timely turning-on.

Another signal quality measurement method provided by Embodiment 4 of the present disclosure can be executed by a network device.

The network device can send RRC signaling to a terminal device, and then determine, after a first time gap, that a measurement object is valid, to give an indication to the terminal device to dynamically add the measurement object to a measurement object list when receiving the RRC signaling; enabling the terminal device to start measurement of the measurement object after the first time gap, or add the measurement object to the measurement object list after the first time gap, so that the terminal device can start the measurement of the target cell after the first time gap, to determine that the measurement object is valid.

In an implementation, the RRC signaling includes a measurement object including a measurement reference signal, and the measurement reference signal is a measurement reference signal on a target cell.

In an implementation, the measurement reference signal includes a synchronization signal block.

In an implementation, the first time gap is a preset time gap.

In an implementation, the first time gap is a configured time gap.

For the description of the above information, reference can be made to Embodiment 2, which will not be repeated here.

In this embodiment, due to slow transmission of the RRC signaling, the network device sends the RRC signaling to the terminal device, and determines, after the first time gap, that the measurement object is valid, to give an indication to the terminal device to determine, after the first time gap, whether the measurement object is valid, so that the time instant at which the target cell sends the measurement reference signal may be slightly later than the arrival time of the RRC signaling. This can minimize transmission of the measurement reference signal by the target cell, to achieve the goal of energy savings.

FIG. 4 is a schematic structural diagram of a signal quality measurement apparatus provided by Embodiment 5 of the present disclosure. The apparatus 40 may be a chip or a chip module. Please refer to FIG. 4, the apparatus 40 includes a determining module 401.

The determining module 401 is configured to determine, based on a physical downlink control channel PDCCH or medium access control-control element MAC-CE signaling, whether a measurement object is valid.

In one possible implementation, the measurement object includes a measurement reference signal, where the measurement reference signal is a measurement reference signal on a target cell.

In one possible implementation, the measurement reference signal includes a synchronization signal block.

In one possible implementation, the PDCCH or the MAC-CE signaling includes an identity ID of the measurement object.

In one possible implementation, the PDCCH or the MAC-CE signaling includes an index or a number of the measurement object.

In one possible implementation, the PDCCH or the MAC-CE signaling includes first information of the measurement object in a candidate measurement object list, where the first information includes any one of the ID, the index, and the number.

In one possible implementation, the PDCCH or the MAC-CE signaling includes one or more PCIs in a physical cell identity PCI list of the measurement object.

In one possible implementation, the PDCCH or the MAC-CE signaling includes a PCI index or number, where the PCI index or number corresponds to the one or more PCIs in the PCI list.

In one possible implementation, the PDCCH or the MAC-CE signaling includes a synchronization measurement timing configuration SMTC of the measurement object.

In one possible implementation, the determining module 401 is further configured to:
based on the PDCCH or the MAC-CE signaling, determine, after a first time gap, whether the measurement object is valid.

In one possible implementation, the first time gap is a preset time gap.

In one possible implementation, the first time gap is a configured time gap.

The apparatus of this embodiment can be used to perform steps of the signal quality measurement method in Embodiment 1, and specific implementations and technical effects are similar, which will not be repeated here.

FIG. 5 is a schematic structural diagram of a signal quality measurement apparatus provided by Embodiment 6 of the present disclosure. The apparatus 50 may be a chip or a chip module. Please refer to FIG. 5, the apparatus 50 includes a determining module 501.

The determining module 501 is configured to: based on radio resource control RRC signaling, determine, after a first time gap, that a measurement object is valid.

In one possible implementation, the measurement object includes a measurement reference signal, where the measurement reference signal is a measurement reference signal on a target cell.

In one possible implementation, the measurement reference signal includes a synchronization signal block.

In one possible implementation, the first time gap is a preset time gap.

In one possible implementation, the first time gap is a configured time gap.

The apparatus of this embodiment can be used to perform steps of the signal quality measurement method in Embodiment 2, specific implementations and technical effects are similar, and will not be repeated here.

FIG. 6 is a schematic structural diagram of a signal quality measurement apparatus provided by Embodiment 7 of the present disclosure. The apparatus 60 may be a chip or a chip module. Please refer to FIG. 6, the apparatus 60 includes a sending module 601.

The sending module 601 is configured to send a physical downlink control channel PDCCH or medium access control-control element MAC-CE signaling to indicate whether a measurement object is valid.

In one possible implementation, the PDCCH or the MAC-CE signaling includes an identity ID of the measurement object.

In one possible implementation, the PDCCH or the MAC-CE signaling includes an index or a number of the measurement object.

In one possible implementation, the PDCCH or the MAC-CE signaling includes first information of the measurement object in a candidate measurement object list, where the first information includes any one of the ID, the index, and the number.

In one possible implementation, the PDCCH or the MAC-CE signaling includes one or more PCIs in a physical cell identity PCI list of the measurement object.

In one possible implementation, the PDCCH or the MAC-CE signaling includes a PCI index or number, where the PCI index or number corresponds to the one or more PCIs in the PCI list.

In one possible implementation, the PDCCH or the MAC-CE signaling includes a synchronization measurement timing configuration SMTC of the measurement object.

In one possible implementation, the PDCCH or the MAC-CE signaling further includes an SMTC index or number, where the SMTC index or number corresponds to one or more SMTCs.

The apparatus of this embodiment can be used to perform steps of the signal quality measurement method in Embodiment 3, specific implementations and technical effects are similar, and will not be repeated here.

FIG. 7 is a schematic structural diagram of a signal quality measurement apparatus provided by Embodiment 8 of the present disclosure. The apparatus 70 may be a chip or a chip module. Please refer to FIG. 7, the apparatus 70 includes a sending module 701.

The sending module 701 is configured to send radio resource control RRC signaling, and determine, after a first time gap, that a measurement object is valid.

In one possible implementation, the RRC signaling includes the measurement object.

The measurement object includes a measurement reference signal, where the measurement reference signal is a measurement reference signal on a target cell.

In one possible implementation, the measurement reference signal includes a synchronization signal block.

In one possible implementation, the first time gap is a preset time gap.

In one possible implementation, the first time gap is a configured time gap.

The apparatus of this embodiment can be used to perform steps of the signal quality measurement method in Embodiment 4, specific implementations and technical effects are similar, and will not be repeated here.

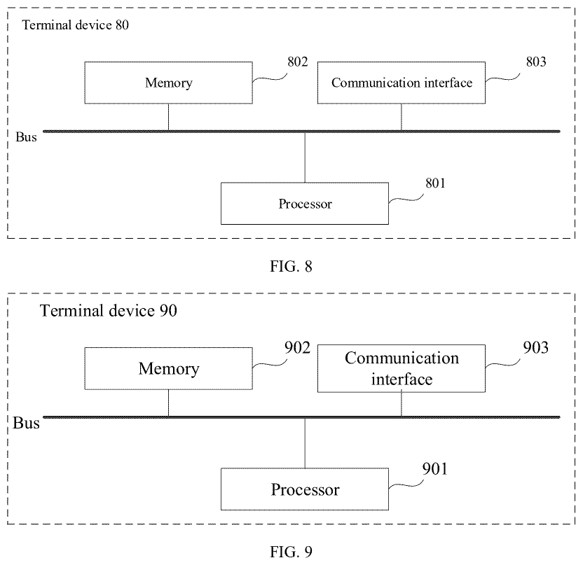

FIG. 8 is a schematic structural diagram of a terminal device provided by Embodiment 9 of the present disclosure. As shown in FIG. 8, the terminal device 80 may include at least one processor 801 and a memory 802.

The memory 802 is used to store a program. Specifically, the program may include program codes including computer execution instructions.

The memory 802 may include a high-speed random access memory (RAM), may also include a non-volatile memory, such as at least one disk storage.

The processor 801 is used to execute the computer execution instructions stored in the memory 802 to implement the methods described in the above method embodiments. The processor 801 may be a central processing unit (CPU), an Application Specific Integrated Circuit (ASIC), or one or more integrated circuits configured to implement the embodiments of the present disclosure.

In an implementation, the terminal device 80 may also include a communication interface 803. In terms of specific implementation, if the communication interface 803, the memory 802 and the processor 801 are implemented independently, the communication interface 803, the memory 802 and the processor 801 can be connected to each other through a bus and communicate with each other. The bus can be an Industry Standard Architecture (ISA) bus, a Peripheral Component Interconnect (PCI) bus, or an Extended Industry Standard Architecture (EISA) bus. And the buses can be divided into address buses, data buses, control buses, and the like, but this does not mean that there is only one bus or one type of bus.

In an implementation, in specific implementation, if the communication interface 803, the memory 802, and the processor 801 are integrated on a single chip, the communication interface 803, the memory 802 and the processor 801 can complete communications through internal interfaces.

The terminal device 80 may be a chip, a module, an IDE, or the like

The terminal device of this embodiment can be used to implement the technical solution of the signal quality measurement method in Embodiment 1, specific implementations and technical effects are similar, and will not be repeated here.

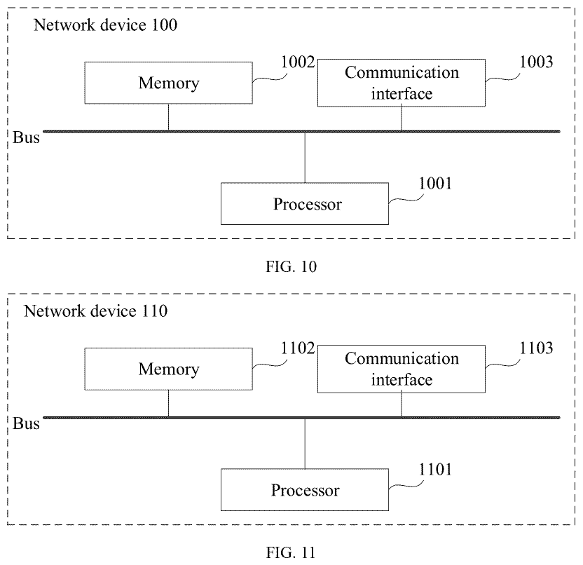

FIG. 9 is a schematic structural diagram of a terminal device provided by Embodiment 10 of the present disclosure. As shown in FIG. 9, the terminal device 90 may include at least one processor 901 and a memory 902.

The memory 902 is used to store a program. Specifically, the program may include program codes including computer execution instructions.

The memory 902 may include a high-speed RAM storage, and may also include a non-volatile storage such as at least one disk storage.

The processor 901 is used to execute the computer execution instruction stored in the memory 902 to implement the methods described in the above method embodiments. The processor 901 may be a CPU, an ASIC, or one or more integrated circuits configured to implement the embodiments of the present disclosure.

In an implementation, the terminal device 90 may also include a communication interface 903. In terms of specific implementation, if the communication interface 903, the memory 902, and the processor 901 are implemented independently, they can be connected to each other through a bus and communicate with each other. The bus can be an ISA bus, a PCI bus, or an EISA bus, or the like. And the buses can be divided into address buses, data buses, control buses, and the like, but this does not mean that there is only one bus or one type of bus.

In an implementation, in terms of specific implementation, if the communication interface 903, the memory 902 and the processor 901 are integrated on a single chip, the communication interface 903, the memory 902 and the processor 901 can complete communications through internal interfaces.

The terminal device 90 may be a chip, a module, an IDE, or the like

The terminal device of this embodiment can be used to implement the technical solution of the signal quality measurement method in Embodiment 2, specific implementations and technical effects are similar, and will not be repeated here.

FIG. 10 is a schematic structural diagram of a network device provided in Embodiment 11 of the present disclosure. As shown in FIG. 10, the network device 100 may include at least one processor 1001 and a memory 1002.

The memory 1002 is used to store a program. Specifically, the program may include program codes including computer execution instructions.

The memory 1002 may include a high-speed RAM memory, and may also include a non-volatile memory such as at least one disk storage.

The processor 1001 is used to execute the computer execution instructions stored in the memory 1002 to implement the methods described in the above method embodiments. The processor 1001 may be a CPU, an ASIC, or one or more integrated circuits configured to implement the embodiments of the present disclosure.

In an implementation, the network device 100 may also include a communication interface 1003. In terms of specific implementation, if the communication interface 1003, the memory 1002 and the processor 1001 are implemented independently, they can be connected to each other through a bus and communicate with each other. The bus can be an ISA bus, a PCI bus, or an EISA bus, or the like. And the buses can be divided into address buses, data buses, control buses, and the like, but this does not mean that there is only one bus or one type of bus.

In an implementation, in specific implementation, if the communication interface 1003, the memory 1002 and the processor 1001 are integrated on a single chip, the communication interface 1003, the memory 1002 and the processor 1001 can complete communications through internal interfaces.

The network device 100 may be a chip, a module, an IDE, or the like

The network device of this embodiment can be used to implement the technical solution of the signal quality measurement method in Embodiment 3, specific implementations and technical effects are similar, and will not be repeated here.

FIG. 11 is a schematic structural diagram of a network device provided by Embodiment 12 of the present disclosure. As shown in FIG. 11, the network device 110 may include at least one processor 1101 and a memory 1102.

The memory 1102 is used to store a program. Specifically, the program may include program codes including computer execution instructions.

The memory 1102 may include a high-speed RAM memory, and may also include a non-volatile memory such as at least one disk storage.

The processor 1101 is used to execute the computer execution instructions stored in the memory 1102 to implement the methods described in the aforementioned embodiments. Among them, the processor 1101 may be a CPU, an ASIC, or one or more integrated circuits configured to implement the embodiments of the present disclosure.

In an implementation, the network device 110 may also include a communication interface 1103. In terms of specific implementation, if the communication interface 1103, the memory 1102 and the processor 1101 are implemented independently, they can be connected to each other through a bus and communicate with each other. The bus can be an ISA bus, a PCI bus, or an EISA bus, or the like. And the buses can be divided into address buses, data buses, control buses, and the like, but this does not mean that there is only one bus or one type of bus.

In an implementation, in terms of specific implementation, if the communication interface 1103, the memory 1102 and the processor 1101 are integrated on a single chip, the communication interface 1103, the memory 1102 and the processor 1101 can complete communications through internal interfaces.

The network device 110 may be a chip, a module, an IDE, or the like.

The network device of this embodiment can be used to implement the technical solution of the signal quality measurement method in Embodiment 4, specific implementations and technical effects are similar, and will not be repeated here.

Embodiment 13 of the present disclosure provides a computer-readable storage medium, where the computer-readable storage medium may include various media that can store computer programs, such as USB flash drives, portable hard drives, Read Only Memories (ROM), RAMs, magnetic disks, or optical disks. Specifically, the computer-readable storage medium stores a computer program therein, where the computer program is used to implement the technical solutions shown in the above method embodiments when executed by a processor. The specific implementations and technical effects are similar and will not be repeated here.

Embodiment 14 of the present disclosure provides a computer program product, including a computer program; the technical solution shown in the above method embodiment is implemented when the computer program is executed by a processor. The specific implementations and technical effects are similar, and will not be repeated here.

Embodiment 15 of the present disclosure provides a chip storing a computer program thereon; the method shown in the above method embodiments is implemented when the computer program is executed by the chip. This chip can also serve as a chip module.

Those skilled in the art will easily come up with other embodiments of the present disclosure after considering the specification and practicing the disclosure disclosed herein. The present disclosure is intended to cover any variations, uses, or adaptive changes of the present disclosure, which follow a general principle of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to a precise structure described above and shown in the accompanying drawings, and various modifications and changes can be made without departing from the scope of the present disclosure. The scope of the present disclosure is limited only by the appended claims.

In a first aspect, the present disclosure provides a signal quality measurement method, including:
determining, based on a physical downlink control channel PDCCH or medium access control-control element MAC-CE signaling, whether a measurement object is valid.

In one possible implementation, the measurement object includes a measurement reference signal, where the measurement reference signal is a measurement reference signal on a target cell.

In one possible implementation, the measurement reference signal includes a synchronization signal block.

In one possible implementation, the PDCCH or the MAC-CE signaling includes an identity ID of the measurement object.

In one possible implementation, the PDCCH or the MAC-CE signaling includes an index or a number of the measurement object.

In one possible implementation, the PDCCH or the MAC-CE signaling includes first information of the measurement object in a candidate measurement object list, where the first information includes any one of the ID, the index, and the number.

In one possible implementation, the PDCCH or the MAC-CE signaling includes one or more PCIs in a physical cell identity PCI list of the measurement object.

In one possible implementation, the PDCCH or the MAC-CE signaling includes a PCI index or number, where the PCI index or number corresponds to the one or more PCIs in the PCI list.

In one possible implementation, the PDCCH or the MAC-CE signaling includes a synchronization measurement timing configuration SMTC of the measurement object.

In one possible implementation, the PDCCH or the MAC-CE signaling includes an SMTC index or number, and the SMTC index or number corresponds to one or more SMTCs.

In one possible implementation, the determining, based on the PDCCH or the MAC-CE signaling, whether the measurement object is valid includes:
based on the PDCCH or the MAC-CE signaling, determining, after a first time gap, whether the measurement object is valid.

In one possible implementation, the first time gap is a preset time gap.

In one possible implementation, the first time gap is a configured time gap.

In a second aspect, the present disclosure provides a signal quality measurement method, including:
based on radio resource control RRC signaling, determining, after a first time gap, that a measurement object is valid.

In one possible implementation, the measurement object includes a measurement reference signal, where the measurement reference signal is a measurement reference signal on a target cell.

In one possible implementation, the measurement reference signal includes a synchronization signal block.

In one possible implementation, the first time gap is a preset time gap.

In one possible implementation, the first time gap is a configured time gap.

In a third aspect, the present disclosure provides a signal quality measurement method, including:
sending a physical downlink control channel PDCCH or medium access control-control element MAC-CE signaling to indicate whether a measurement object is valid.

In one possible implementation, the PDCCH or the MAC-CE signaling includes an identity ID of the measurement object.

In one possible implementation, the PDCCH or the MAC-CE signaling includes an index or a number of the measurement object.

In one possible implementation, the PDCCH or the MAC-CE signaling includes first information of the measurement object in a candidate measurement object list, where the first information includes any one of the ID, the index, and the number.

In one possible implementation, the PDCCH or the MAC-CE signaling includes one or more PCIs in a physical cell identity PCI list of the measurement object.

In one possible implementation, the PDCCH or the MAC-CE signaling includes a PCI index or number, where the PCI index or number corresponds to the one or more PCIs in the PCI list.

In one possible implementation, the PDCCH or the MAC-CE signaling includes a synchronization measurement timing configuration SMTC of the measurement object.

In one possible implementation, the PDCCH or the MAC-CE signaling further includes an SMTC index or number, and the SMTC index or number corresponds to one or more SMTCs.

In a fourth aspect, the present disclosure provides a signal quality measurement method, including:
sending radio resource control RRC signaling, and determining, after a first time gap, that a measurement object is valid.

In one possible implementation, the RRC signaling includes the measurement object;
the measurement object includes a measurement reference signal, where the measurement reference signal is a measurement reference signal on a target cell.

In one possible implementation, the measurement reference signal includes a synchronization signal block.

In one possible implementation, the first time gap is a preset time gap.

In one possible implementation, the first time gap is a configured time gap.

In a fifth aspect, the present disclosure provides a signal quality measurement apparatus, including:
a determining module configured to determine, based on a physical downlink control channel PDCCH or medium access control-control element MAC-CE signaling, whether a measurement object is valid.

In one possible implementation, the measurement object includes a measurement reference signal, where the measurement reference signal is a measurement reference signal on a target cell.

In one possible implementation, the measurement reference signal includes a synchronization signal block.

In one possible implementation, the PDCCH or the MAC-CE signaling includes an identity ID of the measurement object.

In one possible implementation, the PDCCH or the MAC-CE signaling includes an index or a number of the measurement object.

In one possible implementation, the PDCCH or the MAC-CE signaling includes first information of the measurement object in a candidate measurement object list, where the first information includes any one of the ID, index, and number.

In one possible implementation, the PDCCH or the MAC-CE signaling includes one or more PCIs in a physical cell identity PCI list of the measurement object.

In one possible implementation, the PDCCH or the MAC-CE signaling further includes a PCI index or number, where the PCI index or number corresponds to the one or more PCIs in the PCI list.

In one possible implementation, the PDCCH or the MAC-CE signaling includes a synchronization measurement timing configuration SMTC of the measurement object.

In one possible implementation, the determining module is further configured to:
based on the PDCCH or the MAC-CE signaling, determine, after a first time gap, whether the measurement object is valid.

In one possible implementation, the first time gap is a preset time gap.

In one possible implementation, the first time gap is a configured time gap.

In a sixth aspect, the present disclosure provides a signal quality measurement apparatus, including:
a determining module configured to: based on radio resource control RRC signaling, determine, after a first time gap, that a measurement object is valid.

In one possible implementation, the measurement object includes a measurement reference signal, where the measurement reference signal is a measurement reference signal on a target cell.

In one possible implementation, the measurement reference signal includes a synchronization signal block.

In one possible implementation, the first time gap is a preset time gap.

In one possible implementation, the first time gap is a configured time gap.

In a seventh aspect, the present disclosure provides a signal quality measurement apparatus, including:
a sending module, configured to send a physical downlink control channel PDCCH or medium access control-control element MAC-CE signaling to indicate whether a measurement object is valid.

In one possible implementation, the PDCCH or the MAC-CE signaling includes an identity ID of the measurement object.

In one possible implementation, the PDCCH or the MAC-CE signaling includes an index or a number of the measurement object.

In one possible implementation, the PDCCH or the MAC-CE signaling includes first information of the measurement object in a candidate measurement object list, where the first information includes any one of the ID, the index, and the number.

In one possible implementation, the PDCCH or the MAC-CE signaling includes one or more PCIs in a physical cell identity PCI list of the measurement object.

In one possible implementation, the PDCCH or the MAC-CE signaling includes a PCI index or number, where the PCI index or number corresponds to the one or more PCIs in the PCI list.

In one possible implementation, the PDCCH or the MAC-CE signaling includes a synchronization measurement timing configuration SMTC of the measurement object.

In one possible implementation, the PDCCH or the MAC-CE signaling further includes an SMTC index or number, and the SMTC index or number corresponds to one or more SMTCs.

In an eighth aspect, the present disclosure provides a signal quality measurement apparatus, including:
a sending module, configured to send radio resource control RRC signaling and determine, after a first time gap, that a measurement object is valid.

In one possible implementation, the RRC signaling includes the measurement object;
the measurement object includes a measurement reference signal, where the measurement reference signal is a measurement reference signal on a target cell.

In one possible implementation, the measurement reference signal includes a synchronization signal block.

In one possible implementation, the first time gap is a preset time gap.

In one possible implementation, the first time gap is a configured time gap.

In a ninth aspect, the present disclosure provides a terminal device, including: a processor, and a memory connected in communication with the processor;
where the memory stores computer execution instructions;
the processor executes the computer execution instructions stored in the memory to implement the method as described in the first aspect.

In a tenth aspect, the present disclosure provides a terminal device, including: a processor, and a memory connected in communication with the processor;
where the memory stores computer execution instructions;
the processor executes the computer execution instructions stored in the memory to implement the method as described in the second aspect.

In an eleventh aspect, the present disclosure provides a network device, including: a processor, and a memory connected in communication with the processor;
where the memory stores computer execution instructions;
the processor executes the computer execution instructions stored in the memory to implement the method as described in the third aspect.

In a twelfth aspect, the present disclosure provides a network device, including: a processor, and a memory connected in communication with the processor;
where the memory stores computer execution instructions;
the processor executes the computer execution instructions stored in the memory to implement the method as described in the fourth aspect.

In a thirteenth aspect, the present disclosure provides a computer-readable storage medium storing computer execution instructions, where the computer execution instructions are used to implement the signal quality measurement method as described in any one of the first to fourth aspects when executed by a processor.

In a fourteenth aspect, the present disclosure provides a computer program product including a computer program, where the computer program implements the signal quality measurement method as described in any one of the first to fourth aspects when executed by a processor.

In a fifteenth aspect, the present disclosure provides a chip storing a computer program, and the signal quality measurement method as described in any one of the first to fourth aspects is implemented when the computer program is executed by the chip. This chip can also serve as a chip module.

1. A signal quality measurement method, comprising:
determining, based on a physical downlink control channel (PDCCH) or medium access control-control element (MAC-CE) signaling, whether a measurement object is valid.

2. The method according to claim 1, wherein the measurement object comprises a measurement reference signal, wherein the measurement reference signal is a measurement reference signal on a target cell.

3. The method according to claim 2, wherein the measurement reference signal comprises a synchronization signal block.

4. The method according to claim 1, wherein the PDCCH or the MAC-CE signaling comprises an identity (ID) of the measurement object.

5. The method according to claim 1, wherein the PDCCH or the MAC-CE signaling comprises an index or a number of the measurement object.

6. (canceled)

7. The method according to claim 1, wherein the PDCCH or the MAC-CE signaling comprises one or more PCIs in a physical cell identity (PCI) list of the measurement object.

8. (canceled)

9. The method according to claim 1, wherein the PDCCH or the MAC-CE signaling comprises a synchronization measurement timing configuration (SMTC) of the measurement object.

10. (canceled)

11. The method according to claim 1, wherein the determining, based on the PDCCH or the MAC-CE signaling, whether the measurement object is valid comprises:
based on the PDCCH or the MAC-CE signaling, determining, after a first time gap, whether the measurement object is valid.

12. The method according to claim 11, wherein the first time gap is a preset time gap.

13. The method according to claim 11, wherein the first time gap is a configured time gap.

14. A signal quality measurement method, comprising:
based on radio resource control (RRC) signaling, determining, after a first time gap, that a measurement object is valid.

15. The method according to claim 14, wherein the measurement object comprises a measurement reference signal, wherein the measurement reference signal is a measurement reference signal on a target cell.

16. The method according to claim 15, wherein the measurement reference signal comprises a synchronization signal block.

17. The method according to claim 14, wherein the first time gap is a preset time gap.

18. The method according to claim 14, wherein the first time gap is a configured time gap.

19. A signal quality measurement method, comprising:
sending a physical downlink control channel (PDCCH) or medium access control-control element (MAC-CE) signaling to indicate whether a measurement object is valid.

20. The method according to claim 19, wherein the PDCCH or the MAC-CE signaling comprises an identity ID of the measurement object.

21. The method according to claim 19, wherein the PDCCH or the MAC-CE signaling comprises an index or a number of the measurement object.

22. (canceled)

23. The method according to claim 19, wherein the PDCCH or the MAC-CE signaling comprises one or more PCIs in a physical cell identity PCI list of the measurement object.

24. (canceled)

25. The method according to claim 19, wherein the PDCCH or the MAC-CE signaling comprises a synchronization measurement timing configuration SMTC of the measurement object.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
